(19) United States
(12) Patent Application Publication
(10) Pub. No.: US 2025/0053008 A1
(43) Pub. Date: Feb. 13, 2025

(54) OPTICAL WAVEGUIDE WITH INTEGRATED OPTICAL ELEMENTS

(71) Applicant: GOOGLE LLC, Mountain View, CA (US)

(72) Inventor: Joseph Daniel Lowney, Tucson, AZ (US)

(21) Appl. No.: 18/717,938

(22) PCT Filed: Nov. 21, 2022
(86) PCT No.: PCT/US2022/050588

§ 371 Date: Jun. 7, 2024

Related U.S. Application Data
(60) Provisional application No. 63/288,257, filed on Dec. 10, 2021.

(51) Int. Cl. G02B 27/01

(52) U.S. Cl. CPC G02B 27/0172

(57) ABSTRACT

A near-eye display system includes a waveguide having an incoupler configured to receive display light from an optical engine and to redirect the display light into the waveguide. The display system includes one or more integrated optical elements that are each configured to receive the display light and to apply a first optical function to the display light. The waveguide may include one or more encapsulation layers to encapsulate the incoupler and/or at least one of the integrated optical elements.

### BACKGROUND

Some display systems employ a projector, which is an optical device that projects or shines a pattern of light onto another object (e.g., onto a surface of another object, such as onto a projection screen or retina) in order to display an image or video on or via that other object. In conventional projection systems, light is temporally modulated to provide a pattern of light, which is spatially distributed over a two-dimensional display area. The spatial distribution of the modulated pattern of light produces an image at the display area.

### BRIEF SUMMARY OF EMBODIMENTS

In various embodiments, a near-eye display system includes a waveguide having an incoupler configured to receive display light from an optical engine and to redirect the display light into the waveguide. The display system includes one or more integrated optical elements that are each configured to receive the display light and to apply a first optical function to the display light. The waveguide may include one or more encapsulation layers to encapsulate the incoupler and/or at least one of the integrated optical elements.

In an embodiment, a projection system comprises an optical engine configured to output display light corresponding to an image for display, and a waveguide. The waveguide comprises an incoupler configured to receive the display light from the optical engine and to redirect the display light into the waveguide; and at least one integrated optical element configured to receive the display light from the incoupler and to apply a first optical function to the display light.

The at least one integrated optical element may have non-zero optical power, such that the at least one integrated optical element is configured to cause the display light to converge or diverge.

The incoupler may have non-zero optical power and is configured to apply a second optical function to the display light.

The waveguide may include a plurality of integrated optical elements.

The display light may be received from the optical engine at a first surface of the waveguide, and wherein the incoupler and the at least one integrated optical element are disposed at the first surface of the waveguide.

The output display light may be received from the optical engine at a first surface of the waveguide, such that the incoupler and the at least one integrated optical element are disposed at a second surface of the waveguide that is substantially opposite the first surface.

The incoupler and the at least one integrated optical element may be disposed at substantially opposite surfaces of the waveguide.

The at least one integrated optical element may include one or more of a group that includes a meta lens, a metasurface, a non-planar grating structure, or a set of diffraction grating structures that vary in pitch as a function of position.

In certain embodiments, no optical functions are applied to the output display light between the optical engine and the incoupler of the waveguide.

The waveguide may further comprise an encapsulation layer that encapsulates one or more of the incoupler and the at least one integrated optical element.

In an embodiment, a method comprises outputting, into an incoupler of a waveguide, display light corresponding to an image for display; and applying, by at least one integrated optical element of the waveguide, an optical function to the display light.

Applying the optical function to the display light may comprise causing the display light to converge or diverge.

Outputting the display light into the incoupler may comprise applying a second optical function to the display light by the incoupler.

The method may include applying multiple optical functions through the display light via a plurality of integrated optical elements that are integrated into the waveguide.

Outputting the display light into the incoupler may comprise outputting the display light into the incoupler at a first surface of the waveguide, such that applying the optical function to the display light by the at least one integrated optical element includes applying the optical function at the first surface of the waveguide.

Outputting the display light into the incoupler may comprise outputting the display light into the incoupler at a first surface of the waveguide, such that applying the optical function to the display light by the at least one integrated optical element includes applying the optical function at a second surface of the waveguide that is substantially opposite to the first surface.

Applying the optical function by the at least one integrated optical element may include applying the optical function by one or more of a group that includes a meta lens, a metasurface, a non-planar grating structure, or a set of diffraction grating structures that vary in pitch as a function of position.

Outputting the display light into the incoupler may comprise outputting the display light from an optical engine; and applying no optical functions to the display light between the optical engine and the incoupler of the waveguide.

In an embodiment, a near-eye display may comprise a projection system that includes an optical engine configured to output display light corresponding to an image for display, and a waveguide. The waveguide includes an incoupler configured to receive the display light from the optical engine and to redirect the display light into the waveguide, and at least one integrated optical element configured to receive the display light from the incoupler and to apply a first optical function to the display light.

The at least one integrated optical element may be configured to cause the display light to converge or diverge.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a display system having an integrated projection system, in accordance with some embodiments.

FIG. 2 is a diagram illustrating a partially transparent view of a display system that includes a projection system, in accordance with some embodiments.

FIG. 3 is a diagram illustrating an isometric view of a waveguide having an incoupler, an outcoupler, an exit pupil expander, and integrated optical elements, in accordance with some embodiments.

FIG. 4 is a diagram illustrating an isometric view of a portion of a projection system having a waveguide that includes an incoupler and an integrated optical element that are disposed at the same surface of the waveguide, in accordance with some embodiments.

FIG. 5 is a diagram illustrating an isometric view of a portion of a projection system having a waveguide that includes an incoupler and an integrated optical element that are disposed at respectively opposite surfaces of the waveguide, in accordance with some embodiments.

FIG. 6 is a diagram illustrating an isometric view of a portion of a projection system having a waveguide that includes an incoupler having optical power, in accordance with some embodiments.

FIG. 7 is a diagram illustrating an isometric view of a portion of a projection system having an optical engine that is attached to or otherwise disposed at a surface of the waveguide, in accordance with some embodiments.

FIG. 8 is a diagram illustrating an isometric view of a portion of a projection system having a waveguide that includes integrated optical elements for directing light from a light source to a reflective panel, and for incoupling light from the reflective panel, in accordance with some embodiments.

FIG. 9 is an operational flow diagram illustrating an example of a routine for handling display light, such as by a near-eye display system that includes a waveguide in accordance with some embodiments.

### DETAILED DESCRIPTION

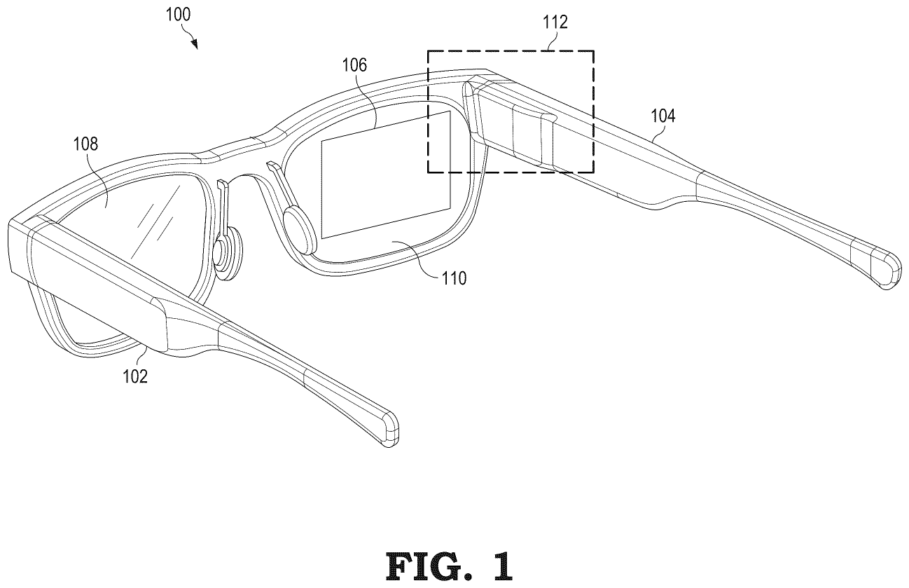

FIGS. 1-8 illustrate embodiments for compactly arranging a near-eye display system (e.g., a wearable heads-up display (WHUD)) or another display system. In accordance with the embodiments described herein, the projection system of a display system includes a waveguide having one or more integrated optical elements having non-zero optical power, which are configured to perform optical functions such as collimation or focusing of light (e.g., by causing light received at such integrated optical elements to converge or diverge). For example, one or more functions that would conventionally be performed using discrete optical elements, such as discrete lenses, are instead performed by one or more integrated optical elements that are integrated in the waveguide, thereby advantageously reducing the form factor of the display system. In various embodiments, the integrated optical elements may include diffraction grating structures (diffraction gratings, which may comprise planar and/or non-planar grating structures), metasurfaces, or meta lenses. As used herein, metasurfaces and meta lenses are materials, typically having sub-wavelength thickness, that modulate the behaviors of electromagnetic waves through specific boundary conditions.

In some embodiments, the waveguide includes an incoupler and an integrated optical element, each of which are a diffraction grating, a metasurface, or a meta lens. The integrated optical element is disposed in an optical path (of light to be projected) between the incoupler and an exit pupil expander of the waveguide in some embodiments. One or both of the incoupler and the integrated optical element have non-zero optical power and thereby cause incident light to converge or diverge to perform an optical function (e.g., collimation, focusing, etc.). In some embodiments, both the incoupler and the integrated optical element are disposed at a first surface of the waveguide at which image-carrying light is received from an optical engine (e.g., a display panel, a laser scanning system, or the like). In other embodiments, both the incoupler and the integrated optical element are disposed at a second surface of the waveguide that is substantially opposite the first surface at which image-carrying light is received by the waveguide. In some embodiments, the incoupler and the integrated optical element are disposed at opposite surfaces of the waveguide. In some embodiments, the waveguide includes the incoupler and does not include an integrated optical element in the optical path between the incoupler and the exit pupil expander, and the incoupler has non-zero optical power and is configured to perform one or more optical functions. The waveguide is configured to have a peak frequency response at a wavelength of green light, such as around 555 nm, in some embodiments, which improves perceptibility of projected images.

In some embodiments, the waveguide is included in a reflective-panel-based projection system. In such embodiments, a light source is disposed at a first surface of the waveguide and a reflective panel is included at a second surface of the waveguide. Light emitted by the light source is output into the waveguide toward a first incoupler, which redirects the light toward a first outcoupler. The first outcoupler redirects the light out of the waveguide and toward the reflective panel. The reflective panel redirects the light back into the waveguide and toward a second incoupler. The second incoupler redirects the light through the waveguide toward an exit pupil expander designed to increase the effective size of a resulting eyebox. (As used herein, eyebox refers to the area in which output from a lightguide may be accurately perceived if the pupil of a human eye is within that eyebox.) The exit pupil expander redirects the light toward a second outcoupler of the waveguide. The second outcoupler of the waveguide projects the light out of the waveguide (e.g., toward an eye of a user) in order for the light to be displayed.

Although some embodiments of the present disclosure are described and illustrated with reference to a particular example near-eye display system in the form of a WHUD, it will be appreciated that the apparatuses and techniques of the present disclosure are not limited to this particular example, but instead may be implemented in any of a variety of display systems using the guidelines provided herein.

FIG. 1 illustrates an example display system 100 employing an optical system in accordance with some embodiments. The display system 100 has a support structure 102 that includes an arm 104, which houses a projector (e.g., a laser projector, a micro-LED projector, a Liquid Crystal on Silicon (LCOS) projector, or the like). The projector is configured to project images toward the eye of a user via a waveguide, such that the user perceives the projected images as being displayed in a field of view (FOV) area 106 of a display at one or both of lens elements 108, 110. In the depicted embodiment, the display system 100 is a near-eye display system in the form of a WHUD in which the support structure 102 is configured to be worn on the head of a user and has a general shape and appearance (that is, form factor) of an eyeglasses (e.g., sunglasses) frame.

The support structure 102 contains or otherwise includes various components to facilitate the projection of such images toward the eye of the user, such as a projector and a waveguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1. It should be understood that instances of the term “or” herein refer to the non-exclusive definition of “or”, unless noted otherwise. For example, herein the phrase “X or Y” means “either X, or Y, or both”.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, a projection system of the display system 100 uses light to form a perceptible image or series of images by projecting the light onto the eye of the user via a projector of the projection system, a waveguide formed at least partially in the corresponding lens element 108 or 110, and one or more optical elements (e.g., one or more scan mirrors, one or more optical relays, or one or more collimation lenses that are disposed between the projector and the waveguide or integrated with the waveguide), according to various embodiments.

In some embodiments, one or more optical elements (e.g., elements having optical power causing received or incident light to converge or diverge, resulting in the light being focused, refracted, collimated, or the like) are integrated with the waveguide, which advantageously reduces the form factor of at least a portion of the display system 100 compared to conventional systems that use only discrete optical elements. One or both of the lens elements 108, 110 include at least a portion of a waveguide that routes display light received by an incoupler of the waveguide to an outcoupler of the waveguide, which outputs the display light toward an eye of a user of the display system 100. The display light is modulated and projected onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

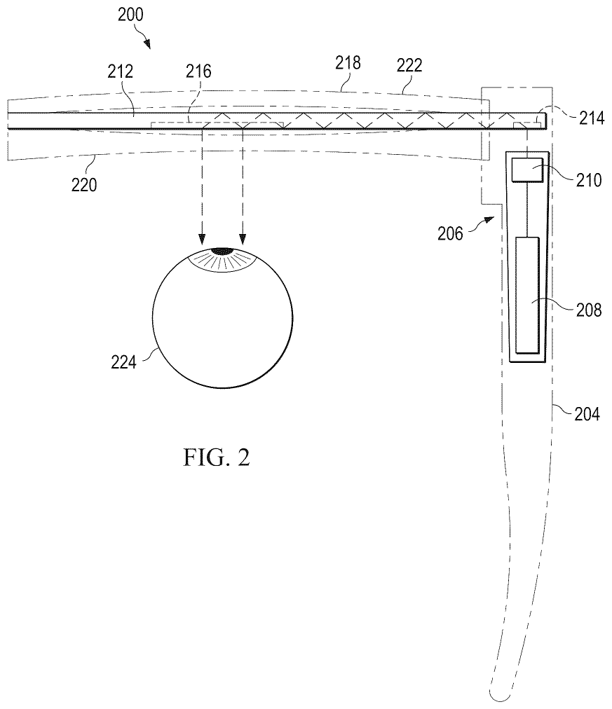

In some embodiments, the projector of the projection system of the display system 100 is a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the projector includes a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the projector includes a Liquid Crystal on Silicon (LCOS) display panel. Herein, such display panels are considered to be part of the optical engine (e.g., the optical engine 208 of FIG. 2) of the corresponding projection system. In some embodiments, a display panel of the projector is configured to output light (representing an image or portion of an image for display) into the waveguide of the projector. The waveguide expands the light and outputs the light toward the eye of the user via an outcoupler.

The projector is communicatively coupled to the controller and a non-transitory processor-readable storage medium or memory storing processor-executable instructions and other data that, when executed by the controller, cause the controller to control the operation of the projector. In some embodiments, the controller controls the projector to selectively set the location and size of the FOV area 106. In some embodiments, the controller is communicatively coupled to one or more processors (not shown) that generate content to be displayed at the display system 100. The projector outputs light toward the FOV area 106 of the display system 100 via the waveguide. In some embodiments, at least a portion of an outcoupler of the waveguide overlaps the FOV area 106. Herein, the range of different user eye positions that will be able to see the display is referred to as the eyebox of the display.

FIG. 2 illustrates a portion of a display system 200 that includes a projection system having a projector 206 and a waveguide 212 with integrated optical elements. In some embodiments, the display system 200 represents the display system 100 of FIG. 1. In the present example, the arm 204 of the display system 200 houses the projector 206, which includes an optical engine 208 (e.g., a display panel), one or more optical elements 210, an incoupler 214, and a portion of the waveguide 212. In some embodiments, one or more optical elements are integrated with the waveguide 212 (e.g., implemented as part of the incoupler 214 or implemented separately from the incoupler 214), such that those optical elements are etched or otherwise formed in an optical substrate comprising a body of the waveguide 212.

The display system 200 includes an optical combiner lens 218, which includes a first lens 220, a second lens 222, and the waveguide 212, with the waveguide 212 embedded or otherwise disposed between the first lens 220 and the second lens 222. Light exiting through the outcoupler 216 travels through the first lens 220 (which corresponds to, for example, an embodiment of the lens element 110 of the display system 100). In use, the light exiting the first lens 220 enters the pupil of an eye 224 of a user wearing the display system 200, causing the user to perceive a displayed image carried by the light output by the optical engine 208. The optical combiner lens 218 is substantially transparent, such that light from real-world scenes corresponding to the environment around the display system 200 passes through the first lens 220, the second lens 222, and the waveguide 212 to the eye 224 of the user. In this way, images or other graphical content output by the projector 206 are combined (e.g., overlayed) with real-world images of the user's environment when projected onto the eye 224 of the user to provide an AR experience to the user.

The waveguide 212 of the display system 200 includes the incoupler 214 and the outcoupler 216. In some embodiments, an exit pupil expander, such as a diffraction grating, is arranged in an intermediate stage between incoupler 214 and outcoupler 216 to receive light that is coupled into waveguide 212 by the incoupler 214, expand the light, and redirect the light towards the outcoupler 216, where the outcoupler 216 then couples the light out of waveguide 212 (e.g., toward the eye 224 of the user). In some embodiments, the waveguide 212 is configured to have a peak frequency response at a wavelength of green light, such as around 555 nm, which improves perceptibility of projected images output by the waveguide 212.

The term “waveguide,” as used herein, will be understood to mean a combiner using one or more of total internal reflection (TIR), specialized filters, or reflective surfaces, to transfer light from an incoupler (such as the incoupler 214) to an outcoupler (such as the outcoupler 216). In some display applications, the light is a collimated image, and the waveguide transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection.

In some embodiments, the incoupler 214 is configured to have non-zero optical power, such that the incoupler 214 causes light incident on or passing through the incoupler 214 to converge or diverge, thereby focusing, collimating, or refracting the light depending on the convergence or divergence applied. Herein, “optical power” refers to a measure of the degree to which an optical element, such a lens or diffraction grating, causes light incident upon or passing through the optical element to bend (e.g., converge or diverge), and is typically measured in units of diopters. It should be noted that optical power of an optical element is the reciprocal of the focal length of the optical element. In some embodiments, one or more optical elements having non-zero optical power are formed integrally with the waveguide 212 (that is, the optical elements are formed on a surface of the waveguide or embedded within the waveguide), such optical elements having non-zero optical power (e.g., being configured to introduce convergence or divergence to received light) and including, for example, any type of optical grating structure, including, but not limited to, diffraction gratings, holograms, holographic optical elements (e.g., optical elements using one or more holograms), volume diffraction gratings, volume holograms, surface relief diffraction gratings, or surface relief holograms. In some embodiments, optical elements having non-zero optical power have curvature with respect to curvature of one or more surfaces if the optical element is a lens, meta lens, or metasurface, or with respect to curvatures of individual grating elements if the optical element is a diffraction grating, such that the curvature causes divergence or convergence of incident light. In some embodiments, such as those in which the optical elements that are diffraction gratings, optical elements having non-zero optical power have grating elements that vary in pitch as a function of position (the function corresponding to a gradient, in some examples), where the variations in grating pitch cause convergence or divergence of incident light. In the present example, the incoupler 214 relays received light to the outcoupler 216 via the waveguide 212 using TIR. The outcoupler 216 then outputs the light to the eye 224 of the user.

In some embodiments, the projector 206 is coupled to a driver or other controller (not shown), which controls the timing of emission of light from light sources (e.g., LEDs) of the optical engine 208 in accordance with instructions received by the controller or driver from a computer processor (not shown) coupled thereto to modulate the output light to be perceived as images when output to the retina of the eye 224 of the user.

For example, during operation of the display system 200, the light sources of the optical engine 208 output display light of selected wavelengths, and the display light is directed to the eye 224 of the user via the optical elements 210 and the waveguide 212. The optical engine 208 modulates the respective intensities of each light source of the optical engine 208, such that the output display light represents pixels of an image. For example, the intensity of a given light source or group of light sources of the optical engine 208 corresponds to the brightness of a corresponding pixel of the image to be projected by the projector 206 of the display system 200.

FIG. 3 shows a partially transparent perspective view (a “front” view) of an embodiment of the waveguide 212 of the display system 200 of FIG. 2 in accordance with some embodiments. As shown, the incoupler 214 redirects received display light toward an exit pupil expander 306, which redirects the display light to the outcoupler 216 to be output (e.g., toward the eye of the user). In some embodiments, one or more optical elements 302 are disposed along the first optical path 304 between the incoupler 214 and the exit pupil expander 306. In some embodiments, a given optical element 302 is an optical grating, such as a diffraction grating, dimensioned to introduce convergence or divergence to display light that is redirected by or otherwise incident upon the optical element 302. That is, the optical element 302 has non-zero optical power. In some embodiments, the optical elements 302 are integrated with (e.g., formed integrally with) the waveguide 212. In some embodiments, the optical elements 302 are omitted, and the incoupler 214 is instead dimensioned to have non-zero optical power.

In some embodiments, the optical functions of one or more optical elements (such as one or more of the optical elements 210 of FIG. 2) that would otherwise be disposed between the waveguide 212 and an optical engine of the display system (such as an embodiment of the optical engine 208 of FIG. 2, are instead implemented via the one or more optical elements 302, the incoupler 214, or combination thereof. Thus, the form factor of the display system that includes the waveguide 212 is advantageously reduced by using integrated optical elements, such as the incoupler 214 or the integrated optical elements 302, to perform optical functions that require non-zero optical power (e.g., corresponding to convergence, divergence, focusing, collimation, or the like), rather than discrete optical elements disposed between, for example, the optical engine (e.g., optical engine 208) and the incoupler 214. In some embodiments, the waveguide 212 is configured to have a peak frequency response at a wavelength of green display light, such as around 555 nm, which improves perceptibility of projected images output by the waveguide 212.

In some embodiments, the exit pupil expander 306 is an optical grating, such as a diffraction grating, that directs display light along a second optical path 308 and that expands one or more dimensions of the eyebox of a display system (e.g., the display system 100 of FIG. 1; the display system 200 of FIG. 2) that includes the waveguide 212 (e.g., with respect to what the dimensions of the eyebox of the display would be without the exit pupil expander 306). In some embodiments, the incoupler 214 and the exit pupil expander 306 each include respective one-dimensional diffraction gratings (i.e., diffraction gratings that extend along one dimension), which diffract incident light in a particular direction depending on the angle of incidence of the incident light and the structural aspects of the diffraction gratings. It should be understood that FIG. 3 shows a substantially ideal case in which the incoupler 214 directs display light down (with respect to the presently illustrated view) in a first direction along the first optical path 304, and the exit pupil expander 306 then directs the display light to the right (with respect to the presently illustrated view) in a second direction along the second optical path 308, where the second direction is substantially perpendicular to the first direction. While not shown in the present example, it should be understood that, in some embodiments, the first direction in which the incoupler 214 directs display light is slightly or substantially diagonal, rather than exactly perpendicular, with respect to the second direction in which the exit pupil expander 306 directs the display light.

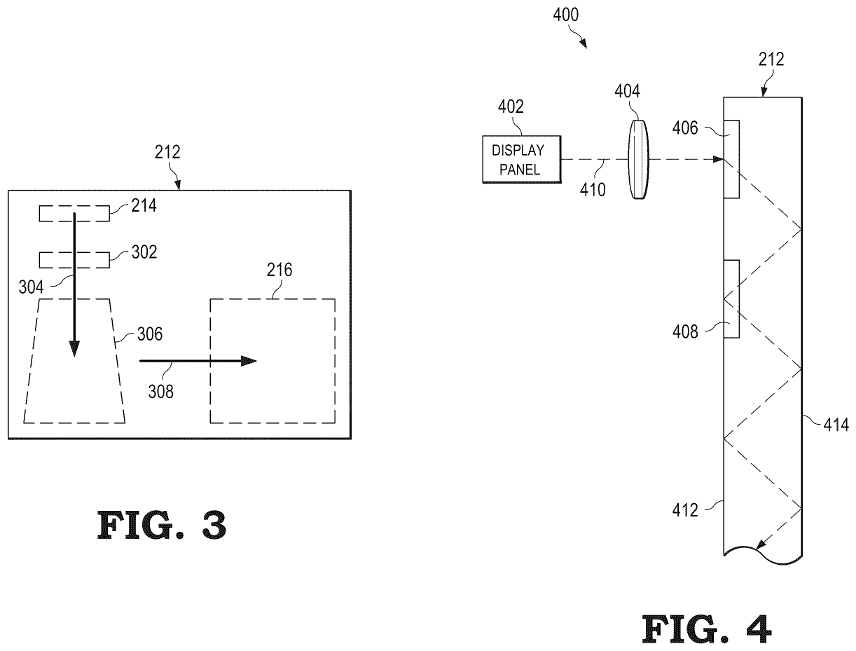

FIG. 4 shows a partially transparent perspective view (a “side” view”) of an embodiment of the waveguide 212 that is included in a projection system 400. In some embodiments, the projection system 400 is included in a display system, such as an embodiment of the display system 100 of FIG. 1 or an embodiment of the display system 200 of FIG. 2. As shown, the projection system 400 includes a display panel 402, the waveguide 212, and one or more optical elements disposed between the display panel 402 and the waveguide 212.

According to various embodiments, the display panel 402 is a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). The display panel 402 is configured to output display light 410 corresponding to an image or a portion of an image to be displayed by the projection system 400. While the display panel 402 is used to generate light for images to be displayed, such as the display light 410, in some embodiments, the projection system 400 instead includes a different type of image source, such as a scanning laser projector, in place of the display panel 402. The optical elements 404 include one or more discrete optical elements such as lenses, mirrors, or the like, configured to change the direction of the display light 410, to apply an optical function to the display light 410 (e.g., collimation, focusing, or the like), or both. In some embodiments, the optical elements 404 are omitted, and optical functions thereof are performed exclusively by one or more integrated optical elements, such as the incoupler 406 and the integrated optical element 408.

In the present example, the waveguide 212 includes an incoupler 406 (an embodiment of the incoupler 214 of FIGS. 2, 3, for example) and an integrated optical element 408. The incoupler 406 and the integrated optical element 408 are both disposed at a first surface 412 of the waveguide 212, opposite a second surface 414 of the waveguide 212. Because the incoupler 406 and the integrated optical element 408 are both disposed at the same surface, the first surface 412, of the waveguide 212, fabrication of the waveguide 212 is simplified, since such an arrangement allows the waveguide 212 to be fabricated by only processing one side of the waveguide 212 in some implementations. In some embodiments, an encapsulation layer is disposed over the first surface 412, which provides protection to elements of the waveguide, such as the incoupler 406 and the integrated optical element 408. By positioning the incoupler 406 and the integrated optical element 408 on the same surface, the first surface 412, of the waveguide 212, such an encapsulation layer can be applied to only one side, while still protecting both incoupler 406 and the integrated optical element 408, in some implementations. In some embodiments, the waveguide 212 is configured to have a peak frequency response at a wavelength of green light, such as around 555 nm, which improves perceptibility of projected images output by the waveguide 212.

In some embodiments, the integrated optical element 408 has a non-zero optical power, such that it causes the display light 410 that is output by the display panel to converge or diverge. In some embodiments, the integrated optical element 408 is a diffraction grating having a non-planar set of grating elements, such as a convex diffraction grating, where the non-planarity of the grating elements causes the integrated optical element 408 to have positive or negative optical power (corresponding to convergence or divergence of light, respectively). In some embodiments, the integrated optical element 408 is a diffraction grating, meta lens, or metasurface having a non-zero optical power. In such embodiments, the integrated optical element 408 is configured to perform one or more optical functions (e.g., due to having non-zero optical power), such as collimating the display light 410 or focusing the display light 410, for example. While a single integrated optical element 408 is shown in the present example, it should be understood that multiple such integrated optical elements (having non-zero optical power and configured to perform respective optical functions) are included in the waveguide, in some implementations. In some embodiments, additionally or alternatively, the incoupler 406 is a diffraction grating, meta lens, or metasurface having non-zero optical power, such that one or more optical functions (e.g., collimation or focusing of the display light 410) are performed by the incoupler 406.

Both the incoupler 406 and the integrated optical element 408 are formed integrally with the waveguide 212. For embodiments in which either or both of the incoupler 406 and the integrated optical element 408 are diffraction gratings, diffraction grating elements (such as grooves) of the incoupler 406, the integrated optical element 408, or both, are formed in or on material (e.g., silicon, glass, polymer, or the like) of the waveguide 212 via, for example, mechanical techniques (e.g., scoring) or chemical techniques (e.g., lithography). For embodiments in which either or both of the incoupler 406 and the integrated optical element 408 are meta lenses or metasurfaces, such metamaterial structures are formed on or in material of the waveguide 212 using lithography, pattern transfer, laser interference lithography, or direct writing, for example.

During operation of the projection system 400, display light 410 forming an image to be displayed is output by the display panel 402. The display light 410 passes through the optical elements 404 and into the waveguide 212 via the incoupler 406. The incoupler 406 redirects the display light 410 into the waveguide 212 and toward the integrated optical element 408 (via TIR). Either or both of the incoupler 406 and integrated optical element 408 have non-zero optical power and cause the display light 410 to converge or diverge, thereby performing an optical function (e.g., collimation, focusing, and the like). The integrated optical element 408 further redirects the display light 410 toward an exit pupil expander (e.g., the exit pupil expander 306 of FIG. 3) of the waveguide 212, where the display light 410 propagates toward the exit pupil expander via TIR within the waveguide 212. The exit pupil expander redirects the display light 410 toward an outcoupler of the waveguide 212 (e.g., the outcoupler 216 of FIGS. 2, 3), which projects the display light 410 out of the waveguide 212 and, for example, toward an eye of a user. By using integrated optical elements, such as the incoupler 406 or the integrated optical element 408, in the waveguide 212 to perform optical functions that involve convergence or divergence of light (i.e., that require non-zero optical power to perform), instead of exclusively using discrete optical elements, such as the optical elements 404, to perform such functions as is done in conventional systems, the form factor of the projection system 400 is advantageously reduced compared to such conventional systems. In some embodiments, the optical elements 404 are omitted, and optical functions thereof are performed exclusively by one or more integrated optical elements, such as the incoupler 406 and the integrated optical element 408.

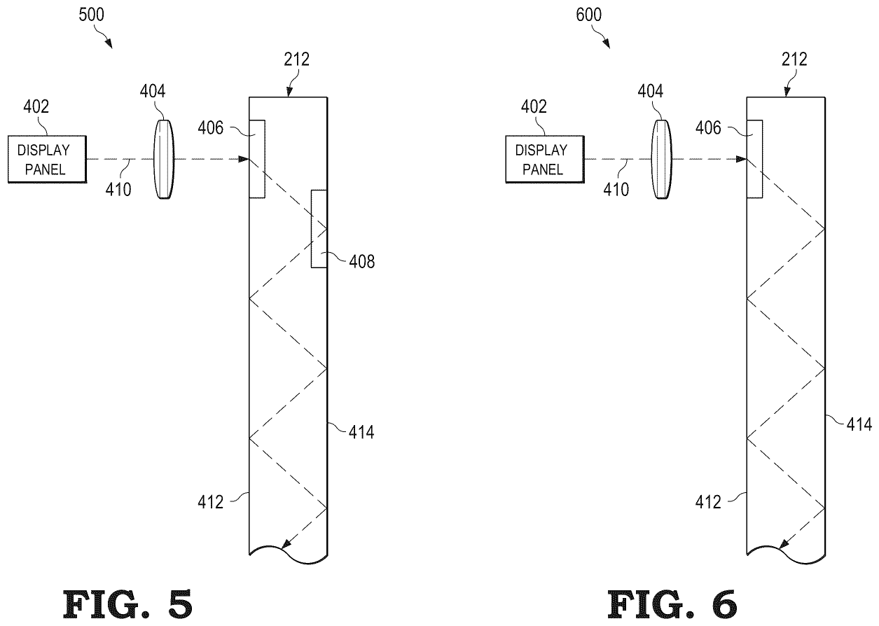

FIG. 5 shows a partially transparent perspective view (a “side” view”) of an embodiment of the waveguide 212 that is included in a projection system 500. In some embodiments, the projection system 500 is included in a display system, such as an embodiment of the display system 100 of FIG. 1 or an embodiment of the display system 200 of FIG. 2. It should be noted that some elements of the projection system 500 are similar to those of the projection system 400, and like reference numerals are used to refer to like elements in the present example. It should be noted that some descriptions of aspects of such elements that are provided above are not repeated here for the sake of brevity.

As shown, the projection system 500 includes the display panel 402, the waveguide 212, and one or more optical elements 404 disposed between the display panel 402 and the waveguide 212. In the present example, the integrated optical element 408 is disposed at the second surface 414 of the waveguide 212 and the incoupler 406 is disposed at the first surface 412. That is, the incoupler 406 and the integrated optical element 408 are disposed on opposite sides of the waveguide 212 from each other. In some implementations, the positioning the incoupler 406 and the integrated optical element 408 on opposite sides of the waveguide 212 advantageously reduces the form factor of the waveguide 212 compared to some arrangements in which the incoupler 406 and the integrated optical element 408 are positioned on the same side of the waveguide 212. In some embodiments, the waveguide 212 is configured to have a peak frequency response at a wavelength of green light, such as around 555 nm, which improves perceptibility of projected images output by the waveguide 212.

During operation of the projection system 500, display light 410 forming an image to be displayed is output by the display panel 402. The display light 410 passes through the optical elements 404 and into the waveguide 212 via the incoupler 406. In some embodiments, the optical elements 404 are omitted, and optical functions thereof are performed exclusively by one or more integrated optical elements, such as the incoupler 406 and the integrated optical element 408. The incoupler 406 redirects the display light 410 into the waveguide 212 and toward the integrated optical element 408. Either or both of the incoupler 406 and integrated optical element 408 have non-zero optical power and cause the display light 410 to converge or diverge, thereby performing an optical function (e.g., collimation, focusing, and the like). The integrated optical element 408 further redirects the display light 410 toward an exit pupil expander (e.g., the exit pupil expander 306 of FIG. 3) of the waveguide 212, where the display light 410 propagates toward the exit pupil expander via TIR within the waveguide 212. The exit pupil expander redirects the display light 410 toward an outcoupler of the waveguide 212 (e.g., the outcoupler 216 of FIGS. 2, 3), which projects the display light 410 out of the waveguide 212 and, for example, toward an eye of a user. As noted above, by using integrated optical elements to perform optical functions that involve convergence or divergence of light (i.e., that require non-zero optical power to perform), instead of only using discrete optical elements (e.g., discrete lenses) to perform such functions as is done in conventional systems, the form factor of the projection system 500 (as well as that of projection systems 600, 700, 800, and 900, each of which is discussed below) is advantageously reduced compared to such conventional systems.

FIG. 6 shows a partially transparent perspective view (a “side” view”) of an embodiment of the waveguide 212 that is included in a projection system 600. In some embodiments, the projection system 600 is included in a display system, such as an embodiment of the display system 100 of FIG. 1 or an embodiment of the display system 200 of FIG. 2. It should be noted that some elements of the projection system 600 are similar to those of the projection system 400, and like reference numerals are used to refer to like elements in the present example. It should be noted that some descriptions of aspects of such elements that are provided above are not repeated here for the sake of brevity.

As shown, the projection system 600 includes the display panel 402, the waveguide 212, and one or more optical elements 404 disposed between the display panel 402 and the waveguide 212. In the present example, rather than including a separate integrated optical element, such as the integrated optical element 408 of FIGS. 4 and 5, the incoupler 406 is provided with a non-zero amount of optical power, such that the incoupler 406 performs one or more optical functions (e.g., collimation, focusing, and the like) via divergence or convergence of the display light 410, in addition to redirecting the display light 410 into the waveguide 212. The incoupler 406 is disposed at the first surface 412 of the waveguide 212. Compared to embodiments of the waveguide 212 that include the integrated optical element 408, less processing of the waveguide 212 is required to fabricate the embodiment of the waveguide 212 of the present example, though the maximum number of optical functions that can be performed by integrated elements of the waveguide 212 is also reduced. Additionally, by providing the incoupler 406 with non-zero optical power, the form factor of the display system that includes the waveguide 212 is advantageously reduced, compared to implementations that instead use a separate optical element to provide such non-zero optical power. In some embodiments, the waveguide 212 is configured to have a peak frequency response at a wavelength of green light, such as around 555 nm, which improves perceptibility of projected images output by the waveguide 212.

During operation of the projection system 600, display light 410 carrying an image to be displayed is output by the display panel 402. The display light 410 passes through the optical elements 404 and into the waveguide 212 via the incoupler 406. In some embodiments, the optical elements 404 are omitted, and optical functions thereof are performed exclusively by one or more integrated optical elements, such as the incoupler 406. The incoupler 406 redirects the display light 410 into the waveguide 212 toward an exit pupil expander (e.g., the exit pupil expander 306 of FIG. 3) of the waveguide 212, where the display light 410 propagates toward the exit pupil expander via TIR within the waveguide 212. The exit pupil expander redirects the display light 410 toward an outcoupler of the waveguide 212 (e.g., the outcoupler 216 of FIGS. 2, 3), which projects the display light 410 out of the waveguide 212 and, for example, toward an eye of a user.

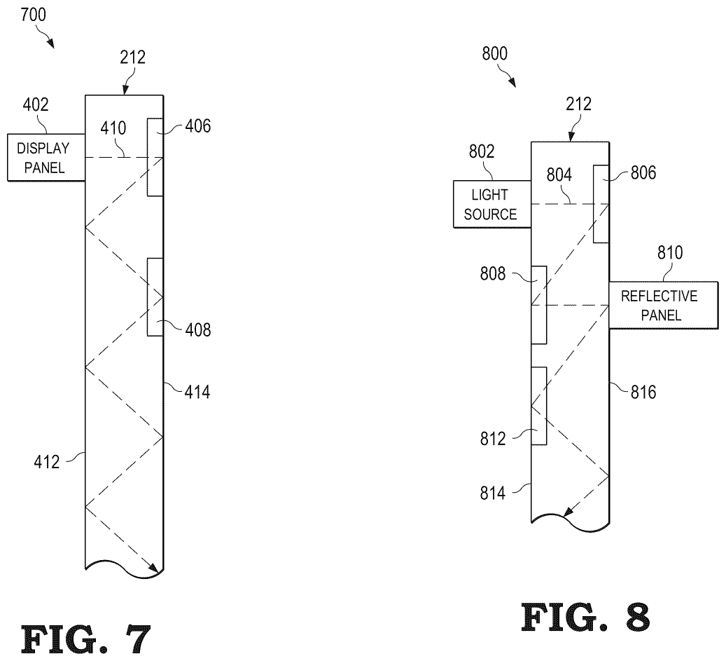

FIG. 7 shows a partially transparent perspective view (a “side” view”) of an embodiment of the waveguide 212 that is included in a projection system 700. In some embodiments, the projection system 700 is included in a display system, such as an embodiment of the display system 100 of FIG. 1 or an embodiment of the display system 200 of FIG. 2. It should be noted that some elements of the projection system 700 are similar to those of the projection system 400, and like reference numerals are used to refer to like elements in the present example. It should be noted that some descriptions of aspects of such elements that are provided above are not repeated here for the sake of brevity.

As shown, the projection system 700 includes the display panel 402 and the waveguide 212. The display panel 402 is disposed directly at the first surface 412 of the waveguide 212, without intervening discrete optical elements (e.g., the optical elements 404 of FIGS. 4-6). In some embodiments, the display panel 402 is adhered to or otherwise attached to the first surface 412 of the waveguide 212. In some embodiments, the display panel 402 is in direct physical contact with the first surface 412 of the waveguide 212. As shown, the incoupler 406 and the integrated optical element 408 are formed in or on the second surface 414 of the waveguide 212. In alternative embodiments, the incoupler 406 and the integrated optical element 408 are otherwise arranged (with the incoupler 406 and the integrated optical element 408 each being disposed at the first surface 412 or with the incoupler 406 and the integrated optical element 408 being disposed at respectively opposite surfaces of the waveguide 212, for example). In some embodiments, the waveguide 212 is configured to have a peak frequency response at a wavelength of green light, such as around 555 nm, which improves perceptibility of projected images output by the waveguide 212.

In the present example, either or both of the incoupler 406 and the integrated optical element 408 have non-zero optical power and are configured to perform respective optical functions that would, conventionally, be performed by discrete optical elements, such as the optical elements 404 of FIGS. 4-6. By performing such optical functions with integrated optical elements (the incoupler 406, the integrated optical element 408, or both) that are formed integrally with the waveguide 212, discrete optical elements can be omitted, allowing direct attachment of the display panel 402 to the first surface 412 of the waveguide 212. This advantageously reduces the amount of scattering undergone by the display light 410, since each optical element passed through typically contributes to such scattering and since, by omitting discrete optical elements and space between the display panel 402 and the waveguide 212, the display light 410 passes few fewer optical elements. Further, by attaching the display panel 402 directly at the first surface 412 of the waveguide 212, the respective form factors of the projection system 700 and display system that includes the projection system 700 are advantageously reduced.

During operation of the projection system 700, display light 410 forming an image to be displayed is output by the display panel 402. The display light 410 passes through the optical elements 404 and into the waveguide 212, then striking the incoupler 406. In some embodiments, the optical elements 404 are omitted, and optical functions thereof are performed exclusively by one or more integrated optical elements, such as the incoupler 406 and the integrated optical element 408. The incoupler 406 redirects the display light 410 into the waveguide 212 toward the integrated optical element 408. The integrated optical element 408 redirects the display light 410 toward an exit pupil expander (e.g., the exit pupil expander 306 of FIG. 3) of the waveguide 212, where the display light 410 propagates toward the exit pupil expander via TIR within the waveguide 212. Either or both of the incoupler 406 and the integrated optical element 408 have non-zero optical power and perform respective optical functions, such as focusing, collimation, or the like, on the display light 410. The exit pupil expander redirects the display light 410 toward an outcoupler of the waveguide 212 (e.g., the outcoupler 216 of FIGS. 2, 3), which projects the display light 410 out of the waveguide 212 and, for example, toward an eye of a user.

FIG. 8 shows a partially transparent perspective view (a “side” view”) of an embodiment of the waveguide 212 that is included in a projection system 800, which is an example of a reflective-panel-based projection system, such as a Liquid Crystal on Silicon (LCOS) projection system. In some embodiments, the projection system 800 is included in a display system, such as an embodiment of the display system 100 of FIG. 1 or an embodiment of the display system 200 of FIG. 2. It should be noted that some descriptions of aspects of elements (e.g., incouplers, outcouplers, waveguides, etc.) that are provided above are not repeated here for the sake of brevity.

As shown, the projection system 800 includes a light source 802, a reflective panel 810, and the waveguide 212. The light source is disposed at a first surface 814 of the waveguide 212 and the reflective panel 810 is disposed at a second surface 816 of the waveguide 212. The waveguide 212 includes at least a first incoupler 806, a first outcoupler 808, and a second incoupler 812. The light source 802 includes, for example, one or more LEDs that generate a display light 804. The display light 804 carries at least a portion of an image to be displayed via the projection system 800. In some embodiments, the waveguide 212 is configured to have a peak frequency response at a wavelength of green light, such as around 555 nm, which improves perceptibility of projected images output by the waveguide 212.

During operation, the light source 802 outputs the display light 804 into the waveguide 212 and toward the first incoupler 806. The first incoupler 806 redirects the display light 804 down the length of the waveguide 212 and toward the first outcoupler 808. In some embodiments, the first incoupler 806 directs the display light 804 toward the first outcoupler 808, such that the display light 804 propagates down the waveguide 212 via TIR. The outcoupler 808 redirects the display light 804 out of the waveguide 212 and toward the reflective panel 810. In some embodiments, the reflective panel 810 includes one or more LCOS panels. The reflective panel 810 reflects the display light 804 back into the waveguide 212 and toward the second incoupler 812. In some embodiments, the second incoupler 812 has non-zero optical power and causes the display light 804 to converge or diverge, thereby performing an optical function (e.g., collimation, focusing, and the like). The second incoupler 812 further redirects the display light 804 toward an exit pupil expander (e.g., the exit pupil expander 306 of FIG. 3) of the waveguide 212, where the display light 804 propagates toward the exit pupil expander via TIR within the waveguide 212. The exit pupil expander redirects the display light 804 toward a second outcoupler of the waveguide 212 (e.g., the outcoupler 216 of FIGS. 2, 3), which projects the display light 804 out of the waveguide 212 and, for example, toward an eye of a user.

Each of the first incoupler 806, the first outcoupler 808, and the second incoupler 812 are formed integrally with the waveguide 212. For some embodiments in which one or more of the first incoupler 806, the first outcoupler 808, and the second incoupler 812 are diffraction gratings, diffraction grating elements (such as grooves) of these gratings, are formed in or on material (e.g., silicon, glass, polymer, or the like) of the waveguide 212 via, for example, mechanical techniques (e.g., scoring) or chemical techniques (e.g., lithography). For embodiments in which one or more of the first incoupler 806, the first outcoupler 808, and the second incoupler 812 are meta lenses or metasurfaces, such metamaterial structures are formed on or in material of the waveguide 212 using lithography, pattern transfer, laser interference lithography, or direct writing, for example.

In some embodiments, the second incoupler 812 has a non-zero optical power, such that it causes the display light 804 that is output by the display panel to converge or diverge. In some embodiments, second incoupler 812 is a diffraction grating having a non-planar set of grating elements, such as a convex diffraction grating, where the non-planarity of the grating elements causes the second incoupler 812 to have positive or negative optical power (corresponding to convergence or divergence of light, respectively). In some embodiments, the second incoupler 812 is a meta lens or metasurface having a non-zero optical power. In such embodiments, the second incoupler 812 is configured to perform one or more optical functions (e.g., due to having non-zero optical power), such as collimating the display light 804 or focusing the display light 804, for example. According to various embodiments, one or more other optical elements that are integrated with the waveguide, such as the first incoupler 806, the first outcoupler 808, or one or more integrated optical elements (e.g., an embodiment of the integrated optical element 408 of FIG. 4), are additionally or alternatively provided in the waveguide 212 having non-zero optical power, with each being configured to perform one or more respective optical functions.

Conventionally, a reflective-panel-based projection system, such as an LCOS projection system, requires a light source, a beam splitter, a mirror, and one or more reflective panels to all be arranged at an input of a waveguide. The amount of space required to house all of these discrete components undesirably impacts the overall form factor of the conventional system. In the present example, some components that are implemented as discrete elements in conventional reflective-panel-based projection systems, such as the beam splitter and mirror, are not required.

For example, functions of the beam splitter and mirror of a conventional reflective-panel-based projection system, such as redirecting light from a light source to the reflective panel and redirecting light from the reflective panel into the waveguide 212, are replaced or otherwise rendered unnecessary, for example, by the illustrated arrangement. For example, the first incoupler 806 and the first outcoupler 808, which are each integrated with the waveguide 212, are used to direct light from the light source 802 to the reflective panel 810. Further, the light source 802 and the reflective panel 810 are disposed directly at (and, in some embodiments, in physical contact with) surfaces of the waveguide 212 with little or no intervening space. Thus, compared to conventional reflective-panel-based projection systems, such as conventional LCOS projection systems, the form factor of the projection system 800 is advantageously reduced by directing light from the light source 802 to the reflective panel 810 (each positioned directly at the waveguide 212) with integrated elements of the waveguide 212 (the first incoupler 806 and the first outcoupler 808).

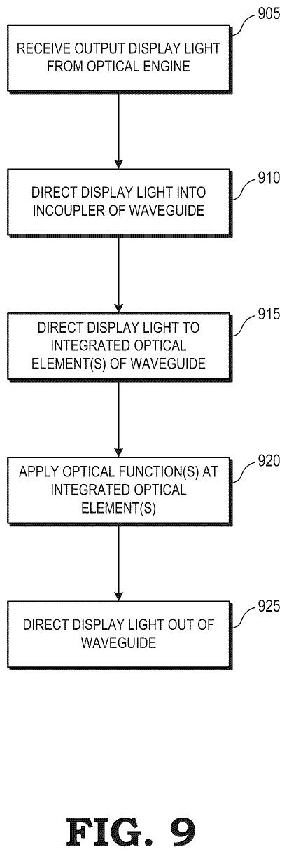

FIG. 9 is an operational flow diagram illustrating an example of a routine for handling display light, such as by a near-eye display system that includes a waveguide in accordance with one or more embodiments. For example, the routine may be performed by display system 100 of FIG. 1, by display system 200 of FIG. 2, or by one or more of projection systems 400, 500, 600, 700, 800 of FIGS. 4-8.

The routine begins at block 905, in which display light representing an image for display is received from an optical engine (e.g., optical engine 208 of FIG. 2, display panel 402 of FIGS. 4-7, or light source 802 of FIG. 8).

At block 910, the received display light is directed into an incoupler of a waveguide, such as discussed elsewhere herein with respect to incoupler 214 and waveguide 212 of FIG. 2, incoupler 406 and waveguide 212 of FIGS. 4-7, and incoupler 806 and waveguide 212 of FIG. 8.

At block 915, the display light is directed to one or more integrated optical elements that are integrated into the waveguide (e.g., integrated optical element(s) 302 of FIG. 3, or integrated optical element 408 of FIGS. 4-5 and 7). Substantially simultaneously, at block 920 one or more optical functions (e.g., collimation, convergence, divergence) are applied to the display light by the one or more integrated optical elements, such as if each integrated optical element applies a respective optical function.

At block 925, the display light is directed out of the waveguide, such as towards an eye of a user.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A projection system comprising:
an optical engine configured to output display light corresponding to an image for display; and
a waveguide comprising:
an incoupler configured to receive the display light from the optical engine and to redirect the display light into the waveguide; and
at least one integrated optical element configured to receive the display light from the incoupler and to apply a first optical function to the display light.

2. The projection system of claim 1, wherein the at least one integrated optical element has non-zero optical power, such that the at least one integrated optical element is configured to cause the display light to converge or diverge.

3. The projection system of claim 1, wherein the incoupler has non-zero optical power and is configured to apply a second optical function to the display light.

4. The projection system of claim 1, wherein the waveguide includes a plurality of integrated optical elements.

5. The projection system of claim 1, wherein the display light is received from the optical engine at a first surface of the waveguide, and wherein the incoupler and the at least one integrated optical element are disposed at the first surface of the waveguide.

6. The projection system of claim 1, wherein the output display light is received from the optical engine at a first surface of the waveguide, and wherein the incoupler and the at least one integrated optical element are disposed at a second surface of the waveguide that is substantially opposite the first surface.

7. The projection system of claim 1, wherein the incoupler and the at least one integrated optical element are disposed at substantially opposite surfaces of the waveguide.

8. The projection system of claim 1, wherein the at least one integrated optical element includes one or more of a group that includes a meta lens, a metasurface, a non-planar grating structure, or a set of diffraction grating structures that vary in pitch as a function of position.

9. The projection system of claim 1, wherein no optical functions are applied to the output display light between the optical engine and the incoupler of the waveguide.

10. The projection system of claim 1, wherein the waveguide further comprises an encapsulation layer that encapsulates one or more of the incoupler and the at least one integrated optical element.

11. A method comprising:
outputting, into an incoupler of a waveguide, display light corresponding to an image for display; and
applying, by at least one integrated optical element of the waveguide, an optical function to the display light.

12. The method of claim 11, wherein applying the optical function to the display light comprises causing the display light to converge or diverge.

13. The method of claim 11, wherein outputting the display light into the incoupler comprises applying a second optical function to the display light by the incoupler.

14. The method of claim 11, comprising applying multiple optical functions through the display light via a plurality of integrated optical elements that are integrated into the waveguide.

15. The method of claim 11, wherein outputting the display light into the incoupler comprises outputting the display light into the incoupler at a first surface of the waveguide, and wherein applying the optical function to the display light by the at least one integrated optical element includes applying the optical function at the first surface of the waveguide.

16. The method of claim 11, wherein outputting the display light into the incoupler comprises outputting the display light into the incoupler at a first surface of the waveguide, and wherein applying the optical function to the display light by the at least one integrated optical element includes applying the optical function at a second surface of the waveguide that is substantially opposite to the first surface.

17. The method of claim 11, wherein applying the optical function by the at least one integrated optical element includes applying the optical function by one or more of a group that includes a meta lens, a metasurface, a non-planar grating structure, or a set of diffraction grating structures that vary in pitch as a function of position.

18. The method of claim 11, wherein outputting the display light into the incoupler comprises:
outputting the display light from an optical engine; and
applying no optical functions to the display light between the optical engine and the incoupler of the waveguide.

19. A near-eye display comprising:
a projection system comprising:
an optical engine configured to output display light corresponding to an image for display; and
a waveguide comprising:
an incoupler configured to receive the display light from the optical engine and to redirect the display light into the waveguide; and
at least one integrated optical element configured to receive the display light from the incoupler and to apply a first optical function to the display light.

20. The near-eye display of claim 19, wherein the at least one integrated optical element is configured to cause the display light to converge or diverge.
